(19) United States
(12) Patent Application Publication
(10) Pub. No.: US 2014/0316872 A1
(43) Pub. Date: Oct. 23, 2014

(54) SYSTEMS AND METHODS FOR MANAGING ENDORSEMENTS

(71) Applicant: Monster, INC., Brisbane, CA (US)

(72) Inventor: Noel Lee, Las Vegas, NV (US)

(21) Appl. No.: 14/191,248

(22) Filed: Feb. 26, 2014

Related U.S. Application Data
(60) Provisional application No. 61/790,011, filed on Mar. 15, 2013.

(51) Int. Cl. G06Q 30/02; G06Q 50/00

(52) U.S. Cl. CPC G06Q 30/0214; G06Q 30/0276; G06Q 50/01
USPC 705/14.16

(57) ABSTRACT

The disclosed embodiments include, for example, a system for managing endorsements for products is disclosed that identifies a person of influence, and determines that the person of influence has identified a product provided by a merchant in a digital communication. The system may dynamically generate an endorsement deal communication including an offer to the person of influence to endorse the product, and provide the endorsement deal communication to the person of influence. The system may receive a response to the endorsement deal communication indicating an acceptance by the person of influence to endorse the product. The system may generate an endorsement communication including a product identifier identifying the product, an endorser identifier identifying the person of influence, and a link to an online location. The system may publish the endorsement communication electronically, after which is determines compensation for the person of influence.

### CROSS-REFERENCE TO RELATED APPLICATION

This application claims the benefit of U.S. Provisional Application No. 61/790,011, filed Mar. 15, 2013.

### FIELD OF THE DISCLOSURE

The disclosed embodiments are generally directed toward computer systems and associated methods for managing endorsements of products or services.

### BACKGROUND

As Internet usage increases, merchants have explored various ways of marketing products they manufacture and/or offer for sale using the Internet. Classic examples of using the Internet to market products include paid banner advertisements, paid placement in search engine results, and direct to consumer emails. Merchants may offer products for sale using websites they operate and maintain, and Internet marketing efforts may direct consumers to their websites so that the consumers may view product information or make product purchases.

Merchants have also explored using social network services as a means to market their products. Social network services include websites where users may share and exchange ideas and information in a community setting. Users may also send and receive comments regarding ideas and information using social network services. The communal nature of social network services can provide a rich ground for product marketing as they may be frequented by a large group of users on a regular basis and provide an opportunity for users to offer and solicit feedback for products. While most social network services accept paid advertising, using social network services to market products through targeted endorsements is a relatively unexplored area.

### SUMMARY

The disclosed embodiments include systems and methods for managing endorsements. In one embodiment, a system for managing online endorsements generates an endorsement for a product sold by a merchant. The endorsement includes endorsement parameters associated with an endorser, and a tracking identifier associated with the endorser. The system may determine that the endorser has included the endorsement in a digital communication based at least in part on detecting the tracking identifier and may determine whether a consumer has visited an online location associated with the merchant based at least in part on the endorsement. The system may determine compensation for the endorser for the endorsement and provide an indication to the endorser of the determined compensation.

The present disclosure also describes a system for providing endorsements where the system identifies a person of influence, and determines that the person of influence has identified a product provided by a merchant in a digital communication. The system may dynamically generate an endorsement deal communication including an offer to the person of influence to endorse the product, and provide the endorsement deal communication to the person of influence. The system may receive a response to the endorsement deal communication indicating an acceptance by the person of influence to endorse the product. The system generates an endorsement communication including a product identifier identifying the product, an endorser identifier identifying the person of influence, and a link to an online location. The system publishes the endorsement communication electronically, after which it determines compensation for the person of influence.

The disclosed embodiments also include a method for managing online endorsements including, for example, generating an endorsement for a product sold by a merchant, the endorsement including endorsement parameters associated with an endorser, and a tracking identifier associated with the endorser. The method may also include determining that the endorser has included the endorsement in a digital communication based at least in part on detecting the tracking identifier and determining whether a consumer has visited an online location associated with the merchant based at least in part on the endorsement. The method may also include determining compensation for the endorser and providing an indication to the endorser of the determined compensation.

In addition, the disclosed embodiments also include a method for managing online endorsements including, for example, identifying a person of influence and determining that the person of influence has identified a product provided by a merchant in a digital communication. The method also includes dynamically generating an endorsement deal communication including an offer to the person of influence to endorse the product, providing the endorsement deal communication to the person of influence, and receiving a response to the endorsement deal communication indicating an acceptance by the person of influence to endorse the product. The method may also include generating an endorsement communication including a product identifier identifying the product, an endorser identifier identifying the person of influence, and a link to an online location. The method may further include electronically publishing the endorsement communication, and determining compensation for the person of influence.

Additional objects and advantages of disclosed embodiments will be set forth in part in the description which follows, and in part will be obvious from the description, or may be learned by practice of the systems and methods. The objects and advantages of the disclosed embodiments may be realized and attained by means of the elements and combinations particularly pointed out in the appended claims. It is to be understood that both the foregoing general description and the following detailed description are exemplary and explanatory only. The accompanying drawings, which are incorporated in and constitute a part of this specification, illustrate several embodiments and together with the description serve to explain the principles of the system and method for managing endorsements.

### BRIEF DESCRIPTION OF THE DRAWINGS

FIG. 1 is a block diagram illustrating an exemplary endorsement management system consistent with certain disclosed embodiments.

FIG. 2A is a block diagram illustrating an exemplary communication flow between an endorsement management system, a social network service, and an endorser device according to one embodiment.

FIG. 2B is a block diagram illustrating an exemplary communication flow between an endorsement management system, a social network service, a payment processor, an endorser device, a consumer device, and a merchant system, according to one embodiment.

FIG. 3 is a block diagram illustrating an endorsement management system according to one embodiment.

FIG. 4 is a flowchart illustrating a process flow performed by an endorsement management system according to one embodiment.

FIG. 5 is a flowchart illustrating a process flow performed by an endorsement management system according to one embodiment.

### DESCRIPTION OF THE EMBODIMENTS

Reference will now be made in detail to exemplary embodiments of the systems and methods for managing endorsements, example of which are illustrated in the accompanying drawings. Wherever possible, the same reference numbers will be used throughout the drawings to refer to the same or like parts. The terminology used in the description presented herein is not intended to be interpreted in any limited or restrictive manner, simply because it is being utilized in conjunction with a detailed description of certain specific embodiments. Furthermore, the described embodiments may include several novel features, no single one of which is solely responsible for its desirable attributes or which is essential to the systems and methods herein described.

The present disclosure describes an endorsement management system that may be used by merchants to market their products using electronic media. The endorsement manage system may identify endorsers, create endorsements, track the effectiveness of the endorsements, and tender payment to endorsers. In some cases, the endorsements are messages endorsing a product that are published using social media, such as websites, blogs, Internet forums, Internet bulletin boards, or some other website providing a platform for users to share and exchange ideas.

In some embodiments, the endorsement management system may identify persons of influence to serve as endorsers of the merchants' products. In certain embodiments, a person of influence may be a well-known celebrity, or it may be a person with a large Internet presence, or a person of certain popularity in certain fields of interest, industries, cultures, etc. The endorsement management system may, for example, identify a user that has a frequently visited blog or a user with a large number of social media contacts as a person of influence. Once a person of interest is identified, the endorsement management system determines whether the person of influence has endorsed a product of the merchant. If so, it tracks the effectiveness of the endorsement. For example, the endorsement management system may track the number of times a consumer visited a website of the merchant as a result of seeing the endorsement, or the endorsement management system may track the number of sales that resulted from the endorsement. Periodically, the endorsement management system may automatically tender payment to the endorser, on behalf of the merchants, for endorsing the merchants' products.

In some embodiments, the endorsement management system may create an endorsement for a product of the merchant and automatically publish the endorsement to a social network service on behalf of the endorser. By creating the endorsement, the endorsement management system advantageously provides a way for the system to track when the endorsement has published, ensures proper formatting for the endorsement for tracking purposes, enables the possibility of utilizing scripts for consumer side tracking, and ensures that the endorsement has a look and feel that is consistent with the merchant's marketing for the product

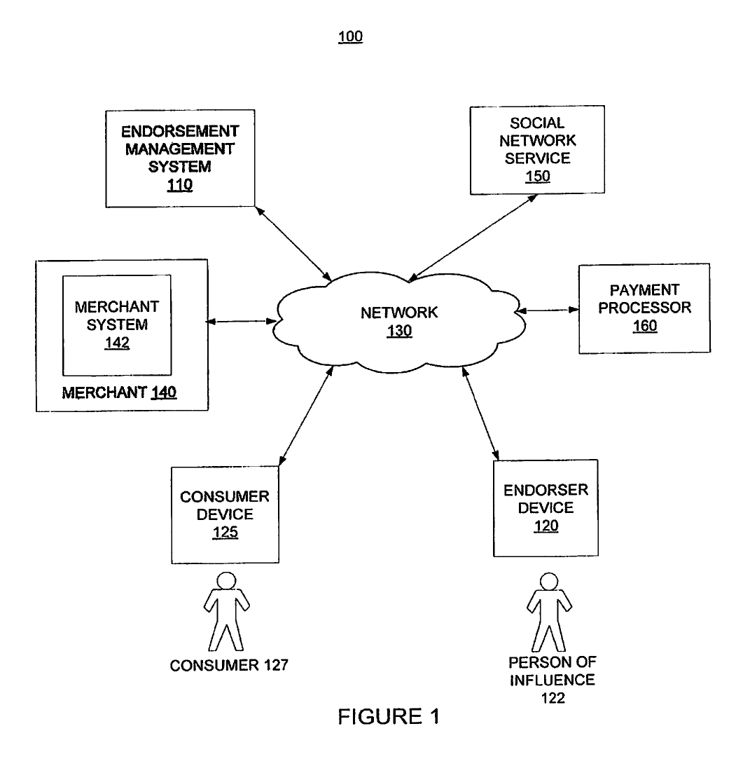

FIG. 1 is a block diagram illustrating an endorsement management system 110 in communication across a network 130 with an endorser device 120, a consumer device 125, a merchant system 142, a social network service 150, and a payment processor 160, according to one embodiment.

The networked system 100 outlined in FIG. 1 may be computerized, wherein each of the illustrated components comprises a computing device that is configured to communicate with other computing devices via the network 130. For example, the consumer device 125 and the endorser device 120 may comprise a computing device, such as a desktop, notebook, or handheld computing device that is configured to transmit and receive data to/from other computing devices via the network 130. Similarly, the endorsement management system 110, the merchant system 142, the social network service 150 and the payment processor 160 may include one or more computing devices that are configured to communicate data with other computing devices via the network 130. Depending on the embodiment, the network 130 may comprise one or more of any type of network, such as one or more local area networks, wide area networks, personal area networks, telephone networks, and/or the Internet, which may be accessed via any available wired and/or wireless communication protocols. For example, the network 130 may comprise a secure LAN through which the endorsement management system 110 and the social network service 120 communicate, and the network 130 may further comprise an Internet connection through which the merchant system 142 and the consumer device 125 communicate. Any other combination of networks, including secured and unsecured network communication links are contemplated for use in the systems described herein.

The endorsement management system 110 may communicate with other computer systems to perform operations such as identifying potential endorsers of products, creating endorsement deal communications, publishing endorsements, tracking endorsements once published, and tendering payment for endorsements. For example, the endorsement management system 110 may communicate with social network service 150 via network 130 to identify potential endorsers of products and to publish endorsements to an endorser's account. The endorsement management system 110 may also be in communication with the endorser device 120 to send endorsement deal communications to a person of influence 122.

The endorsement management system 110 may manage one or more endorser profiles. An endorser profile includes the preferences and attributes of a particular endorser. For example, an endorser profile may include an endorser's name, address, e-mail address, social media account information, and payment preferences. In some embodiments, a user may register with the endorsement management system 110 to become an endorser of the product. For example, a merchant 140 offering a product for sale may approach a person of influence 122 (e.g., a celebrity) and enter into a contract whereby the person of influence 122 agrees to endorse the product using electronic communications (e.g., social media websites, e-mail, text messages). The person of influence 122 may create an endorser profile using a user interface offered by endorsement management system 110 that is accessible by the endorser device 120. For example, endorsement management system 110 may host a webpage that is accessible via a web browser of the endorser device 120 that has one or more forms with text fields, drop down menus, or other user interface elements enabling the person of influence to create an endorser profile.

In some embodiments, the endorsement management system 110 may be configured to automatically identify a person of influence based on the person of influence's online activity. For example, a person of influence may be an individual that writes for a frequently viewed blog, or a person of influence may be a person that has a large number of social media contacts or followers. The endorsement management system 110 may also consider the volume of a person's online activity when determining whether a user is a person of influence. For example, the endorsement management system 110 may determine that a person who posts twice day to her micro-blog of one-thousand followers is a person of influence, but a person who only posts once a month to her micro-blog of two-thousand followers is not a person of influence.

To identify persons of influence, the endorsement management system 110 may be in communication with a social network service 150. The social network service 150 may be a social media website that provides a community for its users to share information and ideas and allows users to post comments regarding the information and ideas. For example, the social network service 150 may be a blog website, a micro-blog website (e.g. Twitter®), an online bulletin board, a forum, a profile-based social media community (e.g., Facebook®, MySpace®, LinkedIn®), or some other interactive online community where users may socialize and exchange ideas. The social network service 150 may include a front-facing interface, such as a website or client side software application, allowing users to access its platform. For example, consumer 127 may access a website provided by the social network service 150 using a browser application installed on consumer device 125, or person of influence 122 may access the social network service 150 using a client side application installed on endorser device 120.

In some embodiments, the social network service 150 may expose application programming interfaces (APIs) permitting other computing systems, such as the endorsement management system 110, to access its content without using the front-facing interface. The API may permit, for example, external computing systems to post messages within the social network service 150, access data concerning the users of the social network service 150, or access data concerning the content posted by users. Periodically, the endorsement management system 110 may access data exposed through the API to identify persons of influence based on their activity on the social networking service.

The endorsement management system 110 may also be in communication with an endorser device 120. The endorser device 120 may be a general personal computing device (such as a laptop, mobile computing device, tablet or some other device) used by the person of influence 122 for general purpose computing tasks. As indicated above, the person of influence 122 may access the endorsement management system 110 via the endorser device 120 to create an endorser profile. In addition, the endorsement management system 110 may communicate with the endorser device 120 to offer the person of influence endorsement deal communications, such as offers to become an endorser or specific endorsement opportunities.

The endorsement management system 110 may also be in communication with a merchant system 142. The merchant system 142 may be one or more computing systems operated and controlled by a merchant 140. The merchant system 142 may execute a webserver providing one or more webpages offering products for sale to consumers. For example, the consumer 127 may access the website of the merchant system 142 using a browser application installed on consumer device 125. In addition, the merchant system 142 may be in communication with the payment processor 160 for processing payments for the purchase of goods made by consumer.

In some embodiments, the endorsement management system 110 provides a front-facing user interface (e.g., a webpage or client application) allowing the merchant system 142 to create generic endorsement messages that may be used to create endorsements specific to a particular person of influence. For example, the merchant 140 may be selling headphones. The merchant 140 may create a generic endorsement that includes a picture of the headphones, a marketing message, and a color scheme matching the marketing associated with the headphones. Using the front-facing user interface, the merchant system 142 may communicate the generic endorsement to the endorsement management system 110. The endorsement management system 110 may then use the generic endorsement to create an endorsement deal communication to a person of influence, and may be published to the account of the person of influence using the social network service 150. By allowing the merchant 140 to create a generic endorsement, the endorsement management system 110 advantageously provides the merchant 140 with the ability to create endorsements that are consistent with the merchant's marketing strategy.

The endorsement management system 110 may also be in communication with a payment processor 160. The payment processor 160 may offer the endorsement management system 110 an interface for providing payments to persons of influence for endorsing products. The payment processor 160 may be any well-known merchant services provider offering payment services to businesses. As the endorsement management system 110 tracks endorsements, it may tender payment to persons of influence for endorsing products through the payment processor 160. The payment processor 160 may expose an API, provide a web service, or provide some other well-known method for allowing the endorsement management system 110 to tender payment to an account of the person of influence 122.

Although FIG. 1 illustrates various computing systems as separate blocks, in some embodiments, the systems may be combined or separated into multiple computing systems without deviating from the spirit and scope of this disclosure. For example, in some embodiments, the endorsement management system 110 and the merchant system 142 may be the same computing system, or the functionality provided in the social network service 150 may be separated into more than one computing system.

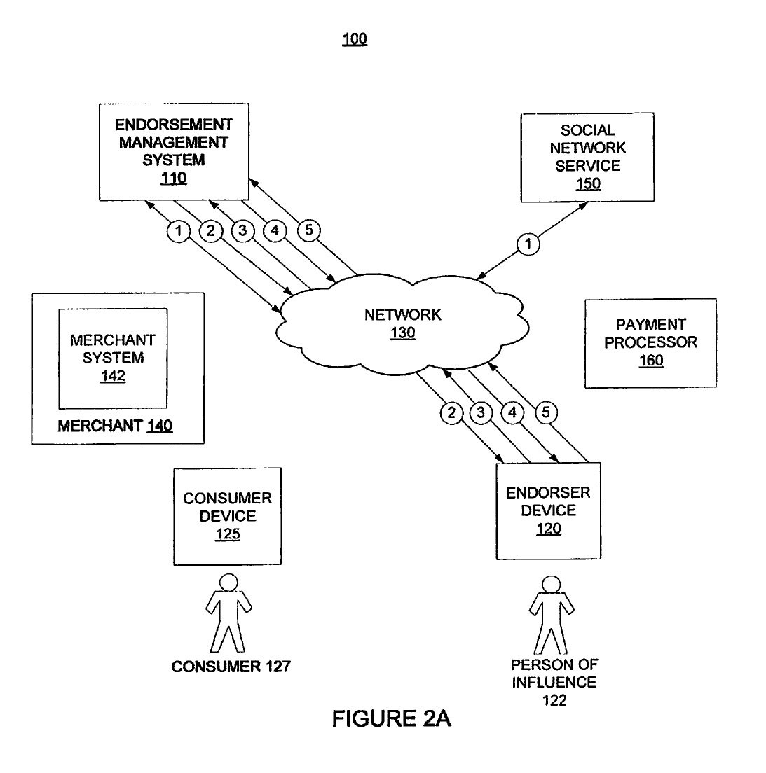

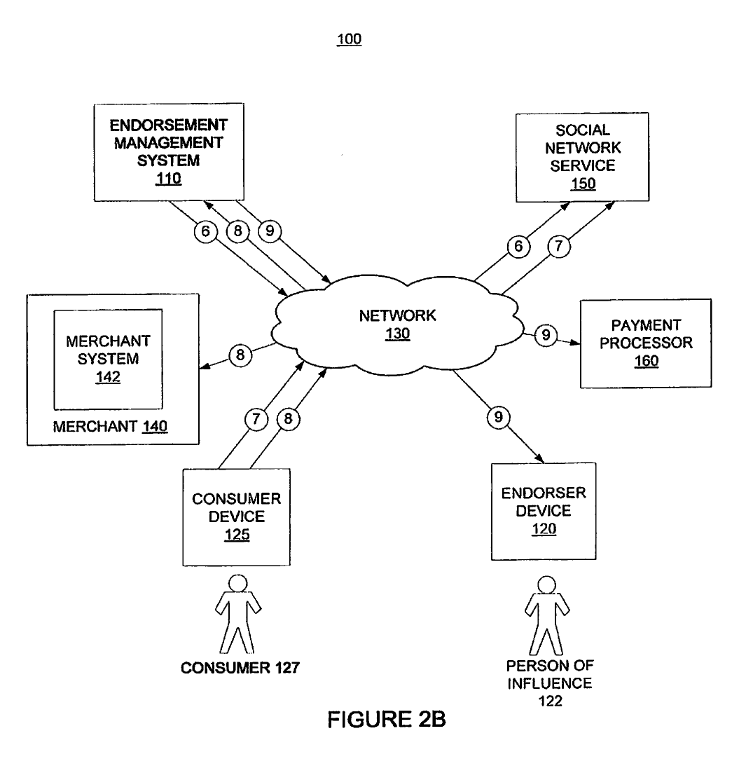

FIGS. 2A and 2B are block diagrams illustrating an exemplary process flow of involving one or more of the computing systems depicted in FIG. 1. In particular, the circled numerals of FIGS. 2A and 2B may illustrate an order in which data flows between the various components of FIG. 1 according to one embodiment. In another embodiment, the steps outlined by the circled numerals may be performed in a different order, and the operations described may include fewer or additional steps.

Turning now to FIG. 2A, at (1), the endorsement management system 110 identifies a person of influence by accessing the data of the social network service 150. The endorsement management system 110 may use an API exposed by the social network service 150 to access its data, or in other embodiments, the social network service 150 may provide a custom data feed to the endorsement management system 110 which the endorsement management system 110 analyzes to identify persons of influence. The endorsement management system 110 may use simple metrics calculated from the social network service's data to identify a person of influence. For example, the endorsement management system 110 may use a simple metric such as the number contacts, followers, or friends of a user.

In some embodiments, the endorsement management system 110 may use a combination of metrics to arrive at a more complicated, derived metric. For example, the endorsement management system 110 may access, from the social network service 150, information about the number of contacts of a user, the number of times the user posts a message to the social network service 150, and the number of comments the user's messages receive. In some embodiments, the endorsement management system 110 may use a weighted formula that takes as input raw data from the social network service and calculates an influence score based on the raw data accessed from the social network service. The endorsement management system 110 may rank users based on the influence score and identify persons of influence based on the rank.

In some embodiments, the endorsement management system 110 identifies persons of influence at (1) generally and without consideration of particular merchant products, industries, geography, or other attributes. In other embodiments, the endorsement management system 110 identifies persons of influence at (1) in the context of a product to endorse, a particular industry, the geography of target consumers, or some other attribute. The identification of persons of influence may be based on preferences supplied by the merchant 140. For example, if a merchant would like to find persons of influence that are athletes, the endorsement management system 110 may include in the person of influence identification process indicators that users of the social network service 150 are athletes. The indicators may include following groups associated with athletics, use of frequent key words (e.g., “gym”), or image recognition techniques to identify that the user has posted images of themselves engaged in athletic activities. In some embodiments, the merchant preferences may be incorporated into a weighted formula that is used to calculate the influence score of users. The endorsement management system 110 may receive from the merchant system 142 a customized weighted formula for determining an influence score. The endorsement management system 110 may, for example, provide a scripting language allowing merchants 140 to define the weighted formula, or may provide a drag-and-drop user interface that merchants 140 may use to create a customizable weighted formula for determining an influence score.

Once the endorsement management system 110 identifies a person of influence, it invites the person to become an endorser at (2). The endorsement management system 110 may invite the person of influence by sending an electronic endorsement deal communication to the endorser device 120. For example, the endorsement management system 110 may send an email to the endorser device using an email address obtained from the data it accessed from the social network service 150, or the endorsement management system 110 may send the person of influence the invitation to the person of influence's social network service account. The endorsement deal communication may include a link that when selected, directs the endorser device to the endorsement management system 110 to register the person of influence 122 with the endorsement management system 110.

At (3), the endorsement management system 110 receives an acceptance of the endorser deal communication. As part of the acceptance, the endorsement management system 110 may provide a user interface (e.g., a webpage) providing the person of influence the opportunity to create an endorsement profile. The endorsement profile may include: the name of the person of influence, social media account information for one or more social media accounts of the person of influence, product endorsement preferences (which may be selectable based on industry, brand, product, price point, etc.), email account information of the person of influence, address, other identification information, and payment preferences. The payment preferences may specify an account to which the endorsement management system 110 tenders payment when it determines that an endorsement was effective. The payment preferences may include the routing number and account number of a bank account, online payment service account information (e.g., PayPal® account), credit card account information, wire transfer information, or some other information that would allow endorsement management system to tender payment to the person of influence 122.

In some embodiments, the endorser profile may also include a default endorsement message that will be added to the endorsements. For example, the person of influence may want to have “I found this great new product” added to its endorsements. When the person of influence creates her endorsement profile, she may specify that her endorsements, by default include the endorsement message.

When the endorsement management system 110 creates an endorsement, it may first provide an endorsement communication describing the endorsement and seeking approval by the person of influence at (4). For example, if the endorsement management system 110 creates an endorsement that is to be published to the social network account of a person of influence 122, the endorsement management system 110 may create an endorsement communication and email it to the person of influence. The endorsement communication may include a sample of the endorsement and provide a selectable user interface element such as button or hyperlink that allows the person of influence to accept the sample endorsement in the endorsement communication. The person of influence 122 may also have an opportunity to alter part of the endorsement, such as text, as part of the approval process. When the person of influence 122 selects the selectable user interface element, the endorser device 120 may send a communication indicating the acceptance to the endorsement management system.

FIG. 2B shows a block diagram illustrating an exemplary process flow for publishing and tracking an endorsement consistent with certain disclosed embodiments. At (6), the endorsement management system 110 publishes the approved endorsement to the social network service 150 on behalf of the person of influence 122. The endorsement management system 110 may use, for example, the social media account information in the endorser profile of the person of influence 122 to post the endorsement to the social network service 150.

A consumer 127 may visit the social network service 150 where the endorsement was published at (7). After viewing the endorsement, the consumer 127 may want to find out more information about the product being endorsed. The consumer may perform a mouse event (e.g., click, mouse-over) on the endorsement, thereby selecting it at (8). The endorsement may include one or more mechanisms that allow tracking the consumer's interest in a product to the endorsement. The endorsement may contain a selectable user interface element such as a button or hyperlink that will direct the consumer device to the merchant system 142 to view product information or to purchase the endorsed product. When selected, the button or hyperlink may first direct the consumer device to the endorsement management system 110 to record the selection, and the endorsement management system 110 may direct the user to the merchant system 142 so that, the consumer may view additional product information or purchase the product.

In some embodiments, the published endorsement contains information that may be used to track when consumers react to the endorsement. For example, the endorsement may include a script that executes when the consumer performs a mouse event. The script may send a message to the endorsement management system 110 indicating that a consumer performed a mouse event on the endorsement. In some embodiments, the script may begin executing a client side program tracking the consumer's viewing behavior for a period of time after the mouse event, and report back to the endorsement management system 110 if the consumer visits the merchant system 142 to view additional details of the product, or performs other activity related to the product (such as searching for the product on a website of a third party vendor). Also, in some embodiments, the script may store a cookie on the consumer device detectable by the merchant system. Thus, when the consumer visits the merchant system 142 at a later time, the endorsement management system 110 or the merchant system 142 may attribute the visit to the endorsement.

Once the consumer 127 reacts to the endorsement, the endorsement management system 110 may calculate payment for the person of influence. The amount of the payment may be determined based on a standard rate card providing value for a particular consumer event. For example, the rate card may specify that publishing an endorsement is valued at $0.02, a consumer viewing additional product information as a result of the endorsement is valued at $0.10 or that a consumer purchasing the product as a result of the endorsement is valued at $1.00. In some embodiments, the endorsement management system 110 provides an opportunity for a merchant 140 to establish rate cards for particular products or marketing campaigns. Also, in some embodiments, the rate card may specify value that is not monetary, such as credits or merchandise. For example, a merchant may offer a free product in exchange for an endorser agreeing to publish an endorsement on her social media account.

Furthermore, in some embodiments, the endorsement management system 110 may provide a bidding marketplace that allows registered persons of influence to bid for the opportunity to endorse products, and the rate card for the endorsement may be set according to the bid to endorse the product. For example, a merchant 142 may seek endorsements for audio speakers, and may specify that registered persons of influence satisfying the merchant's qualifications (e.g., particular influence, geographic area, industry) may bid for endorsements. The endorsement management system 110 may then notify persons of influence that satisfy the merchant's qualifications of the opportunity to endorse. When interested, the persons of influence may bid the amounts for the rate card. The endorsement management system 110 may then offer the endorsements to those persons of influence that submitted the lowest rate card bids.

Once the endorsement management system 110 determines the amount to pay a person of influence, it may tender payment using the payment processor 160. The payments may be made on a periodic basis, such as monthly. The endorsement management system 110 may use the payment information of the endorsement profile of the person of interest to tender payment. In some embodiments, the endorsement management system 110 may also send a notification to the endorser device 120 to inform the person of influence 122 of the payment.

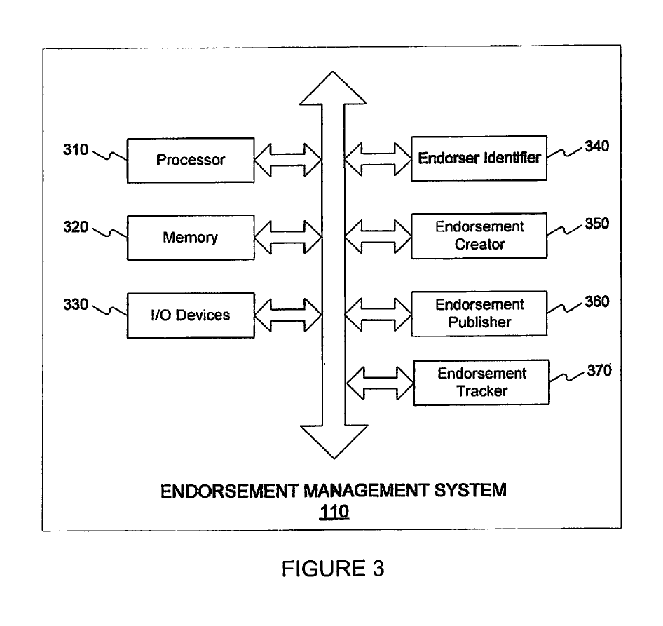

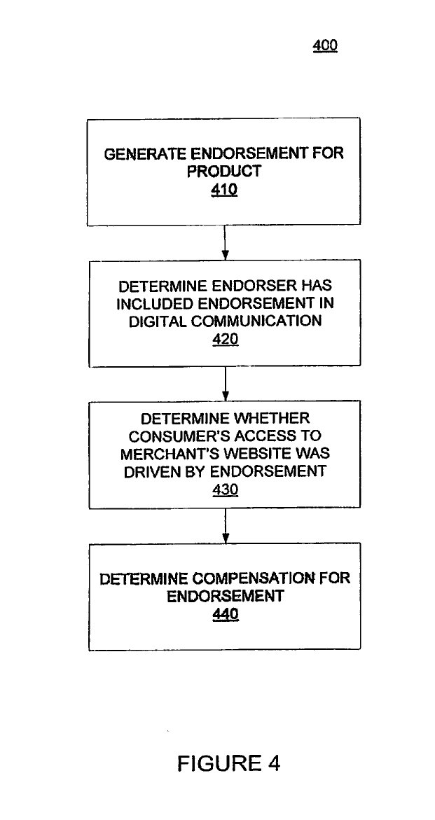

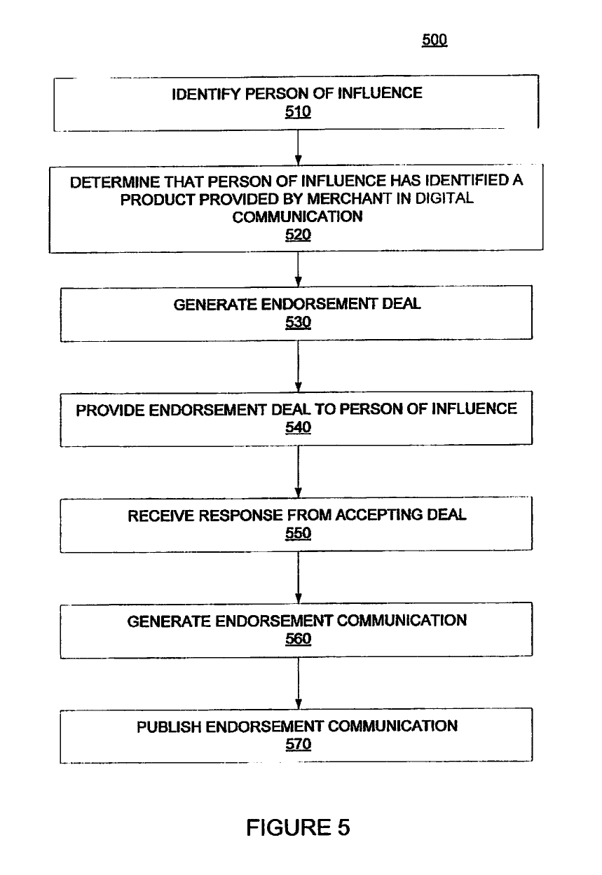

FIG. 3 is a block diagram illustrating an endorsement management system according to one embodiment. In one embodiment, endorsement management system 110 is configured to interface with multiple devices and/or data sources, such as in the exemplary network configurations of FIG. 1. Endorsement management system 110 may be used to implement certain systems and methods described herein. For example, in one embodiment endorsement management system 110 may be configured to perform the process steps described below with respect to FIGS. 4 and 5. To perform its operations, the endorsement management system 110 may include several application modules that may be executed by the processor 310. More particularly, the application modules include endorser identifier 340, endorsement creator 350, endorsement publisher 360, and endorsement tracker 370. The functionality provided for in the components and modules of endorsement management system 110 may be combined into fewer components and modules, or further separated into additional components and modules.

In general, the word module, as used herein, refers to logic embodied in hardware or firmware, or to a collection of software instructions, possibly having entry and exit points, written in a programming language, such as, for example, C, C++, or C#, Java, or some other commonly used programming language. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules may be stored in any type of computer-readable medium, such as a memory device (e.g., random access, flash memory, and the like), an optical medium (e.g., a CD, DVD, BluRay, and the like), firmware (e.g., an EPROM), or any other storage medium. The software modules may be configured for execution by one or more processors in order to cause the endorsement management system 110 to perform particular operations. It will be further appreciated that hardware modules may be comprised of connected logic units, such as gates and flip-flops, and/or may be comprised of programmable units, such as programmable gate arrays or processors. Generally, the modules described herein refer to logical modules that may be combined with other modules or divided into sub-modules despite their physical organization or storage.

In one embodiment, the endorsement management system 110 includes, for example, a server or a personal computer that is IBM, Macintosh, or Linux/Unix compatible. In another embodiment, the endorsement management system 110 comprises a laptop computer, smart phone, personal digital assistant, or other computing device, for example. In one embodiment, the endorsement management system 110 includes one or more processors 310, which may include one or more conventional or proprietary microprocessors. The endorsement management system 110 further includes a memory 320, such as random access memory (“RAM”) for temporary storage of information and a read only memory (“ROM”) for permanent storage of information, such as software instructions. Typically, the modules of the endorsement management system 110 are in communication with one another via a standards based bus system. In different embodiments, the standards based bus system could be Peripheral Component Interconnect (PCI), Microchannel, SCSI, Industrial Standard Architecture (ISA) and Extended ISA (EISA) architectures, for example. In another embodiment, the endorsement management system 110 leverages computing and storage services available over the Internet (cloud computing).

The endorsement management system 110 is generally controlled and coordinated by operating system and/or server software which may include commercially available operating systems, such as Windows® operating systems, UNIX™ based operating systems, or Macintosh® operating systems. In another embodiment, the endorsement management system 110 may be controlled by a custom, proprietary operating system designed specifically for use by an the endorsement management system 110. Conventional operating systems control and schedule computer processes for execution, perform memory management, provide file system, networking, and I/O services, and provide a user interface, such as a graphical user interface (“GUI”), among other things.

The endorsement management system 110 may include one or more commonly available input/output (I/O) devices 330, such as a keyboard, mouse, touchpad, and printer. In one embodiment, the I/O devices and interfaces 230 include one or more display device, such as a monitor, that allows the visual presentation of data to a user. In one embodiment, I/O devices 230 comprise devices that provide a communication interface between the modules of the endorsement management system 110 and external computing devices. For example, the I/O devices 230 may include a network adapter.

The endorser management system 110 may include an endorser identifier 340. The endorser identifier 340 may perform the operations as described herein to identify persons of influence and to manage endorsement profiles. For example, the endorser identifier 340 may periodically analyze data accessed from social network service 150 to identify persons of influence. The endorser identifier 340 may also send endorsement deal communications to persons of influence. The endorser identifier 340 may also generate user interfaces that are used by the endorsement management system 110 and the endorser device 120 during the process of endorser profile creation and modification.

The endorser management system 110 may also include an endorsement creator 350. The endorser creator 350 may perform the operations described herein to create endorsements for products of merchants. For example, the endorser creator 350 may accept endorsement templates from merchants that specify the language and look-and-feel of endorsements. Furthermore, the endorsement creator 350 may also send endorsement communications to the endorser device 120 including sample endorsements for approval, and it may also handle the acceptance or rejection of endorsements by persons of influence.

The endorser management system 110 may also include an endorsement publisher 360. The endorsement publisher 360 may perform the operations described herein to publish an endorsement to a person of influence's account on the social network service 150. For example, the endorsement publisher 360 may access the endorser profile of the person of influence to determine the person of influence's login credentials, and use the credentials to post a message to the person of influence's social network service account. The endorsement publisher 360 may also format the endorsement of multiple social networking platforms.

The endorsement management system 110 may also include an endorsement tracker 370. The endorsement tracker 370 may perform the operations described herein related to tracking consumer activity based on published endorsements and tendering payment to persons of influence. For example, the endorsement tracker 370 may track when consumers view additional product information as a result of viewing an endorsement, perform Internet searches as a result of viewing an endorsement, or purchase a product as a result of an endorsement. As it tracks consumer activity related to published endorsements, the endorsement tracker 370 may also calculate the proper amount of value to tender to the person of influence. The endorsement tracker may also establish communication with the payment processor 160 to tender payment.

FIG. 4 is a flowchart illustrating a process flow for an exemplary method 400 that may be performed by the endorsement management system 110 according to one embodiment. The method 400 may be used by the endorsement management system 110 in embodiments where endorsers have agreed to endorse products and publish the endorsements to their social media service accounts, e.g., in embodiments where the endorsement management system may not automatically publish endorsements on behalf of the endorsers.

The method 400 may begin at block 410 where the endorsement management system 110 generates an endorsement for a product of a merchant. In some embodiments, the endorsement may include parameters. The parameters may include, for example, a rate card indicating payments for consumer activities that are specific to an endorser. The parameters may also include social media services on which the endorsement may be published, text associated with the endorser, text associated with the product, images associated with the endorser and/or product, or other information that may make an effective endorsement. The endorsement may also include a tracking identifier for tracking whether the endorsement is published or whether a consumer has expressed interest in the endorsement (e.g., using a mouse event). In some embodiments, the parameters may include time period parameters that indicate the period for which the endorsement is effective. When the endorser publishes the endorsement outside of the effective period, the endorser may not receive credit for the publication or consumer activity that results from the endorsement.

At block 420, the endorsement management system 110 may determine that an endorser has included the endorsement in a digital communication. For example, the endorsement management system 110 may receive data from the social network service 150 about its content. The endorsement management system may analyze the data and search for the tracking identifier or may search for product key words in the publications of the endorser. The endorser may, in some embodiments, publish the endorsement via a text message or an email, and the endorsement management system 110 may be notified of the publication once it detects activity of consumers based on the endorsement.

After the method 400 determines that the endorser has published the endorsement, the endorsement management system 110 may determine whether a consumer's access to a merchant system website was driven by the endorsement. This may be accomplished through the tracking techniques described above with respect to FIG. 2B. Other tracking techniques may also be employed. For example, the consumer may enter an offer code that was published with the endorsement, or the browsing history of the consumer may be analyzed to determine if the consumer viewed the endorsement within a particular time period before visiting the merchant system website.

Method 400 may also include determining compensation for the endorsement at block 440. The compensation may be determined based on the number of consumers that have visited the merchant system website as a result of the endorsement, the number of consumers that have purchased a product as a result of the endorsement, whether the endorsement begins trending on a social network service or search engine, or some other metric determined by merchants. After the compensation is determined, payment may be tendered to the endorser.

FIG. 5 is a flowchart illustrating an exemplary process flow for a method 500 that may be performed by the endorsement management system 110 according to one embodiment. The method 500 may be performed by the endorsement management system 110 in embodiments where the endorsement management system 110 automatically publishes endorsements to a person of influence's social media service account. Parts of the method 500 may also be performed in embodiments where the endorsement management system 110 searches for, and identifies, persons of influence based on this online activity.

At block 510, the endorsement management system 110 may identify a person of influence. According to one embodiment, the endorsement management system 110 may identify a person of influence based on their online activity and may determine an influence score as described above with respect to FIG. 2A. In some embodiments, the endorsement management system 110 may target persons of influence that are predisposed to endorse products of the merchant by determining that they have identified the product in a digital communication at block 520. The endorsement management system 110 may analyze data provided by one or more social network services to perform block 520.

At block 530, the endorsement management system 110 may generate an endorsement deal. The endorsement deal may include, for example, an offer to endorse a product, the rate card for the endorsement, and other terms specifying the endorsement relationship between the person of influence and the merchant. Once the endorsement deal is generated, the endorsement management system 110 may provide the endorsement deal in a communication to the person of influence at block 540.

At block 550, the endorsement management system 110 may receive a response indicating the person of influence has accepted the endorsement deal. The acceptance may include information that can be used by the endorsement management system 110 to generate an endorser profile. The information may include identification for the endorser and payment information for the endorser.

When a merchant would like to use the endorsement management system 110 to market a product, the endorsement management system 110 may generate an endorsement communication (block 560). The endorsement communication 560 may include a sample of the product endorsement and rate card information for the endorser. The endorsement management system 110 sends the endorsement communication to the endorser for approval. Once approved, the endorsement management system 110 publishes the endorsement communication at block 570. The endorsement communication may be published to a social network service account of the endorser using the social network service account credentials that are part of the person of influence's endorser profile.

Other embodiments of the systems and methods for managing endorsements will be apparent to those skilled in the art from consideration of the specification and through practice. It is intended that the specification and examples be considered as exemplary only, with a true scope and spirit of the disclosure being indicated by the following claims.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

In addition, one or more components of the disclosed embodiments may be implemented as one or more computing systems that are configured to execute software instructions to perform one or more operations consistent with the disclosed embodiments. The computing systems may include one or more processors and one or more memories storing software instructions that may be executed by the one or more processors. In certain aspects, the one or more computing system may be one or more general purpose computers, mainframe computers, desktop computers, mobile devices, tablets, or any combination of these components. In certain embodiments, the one or more computing systems may be configured as one or more particular apparatus, systems, and the like based on the storage, execution, and/or implementation of the software instructions that perform one or more operations consistent with the disclosed embodiments.

What is claimed is:

1. A system for managing online endorsements, comprising:
a. one or more memories storing software instructions; and
b. one or more processors configured to execute the software instructions to perform operations including:
i. generating an endorsement for a product sold by a merchant, the endorsement including:
1. endorsement parameters associated with an endorser; and
2. a tracking identifier associated with the endorser;
ii. determining that the endorser has included the endorsement in a digital communication based at least in part on detecting the tracking identifier;
iii. determining whether a consumer has visited an online location associated with the merchant based at least in part on the endorsement;
iv. determining compensation for the endorser for the endorsement; and
v. providing an indication to the endorser of the determined compensation.

2. The system of claim 1, wherein the endorsement parameters include at least one of:
a. a time period parameter reflecting a time period for the endorser to endorse the product;
b. a product identity parameter identifying the product;
c. an online communication parameter identifying one or more types of online communication mechanisms that the first endorser may use to endorse the product; and
d. a compensation parameter reflecting compensation for the endorser for endorsing the first product.

3. The system of claim 1, wherein the digital communication includes a social network message.

4. The system of claim 1, wherein the online location is a webpage that includes content associated with the product.

5. The system of claim 1, wherein the determining compensation for the endorser is based at least in part on the number of visitors to the online location that are associated with the endorsement.

6. The system of claim 1, wherein the determining compensation for the endorser is based at least in part on the number of visitors associated with the endorsement that purchased the product.

7. The system of claim 1, wherein the operation of generating the endorsement includes accessing an endorsement profile associated with the endorser.

8. The system of claim 7, wherein the operations further include:
a. accessing a payment system associated with the endorser; and
b. providing payment to the endorser by way of the payment system, wherein the payment system is identified in the endorsement profile.

9. A system for managing online endorsements, including:
a. one or more memories storing software instructions; and
b. one or more processors configured to execute the software instructions to perform operations including:
i. identifying a person of influence;
ii. determining that the person of influence has identified a product provided by a merchant in a digital communication;
iii. dynamically generating an endorsement deal communication including an offer to the person of influence to endorse the product;
iv. providing the endorsement deal communication to the person of influence;
v. receiving a response to the endorsement deal communication indicating an acceptance by the person of influence to endorse the product;
vi. generating an endorsement communication including:
1. a product identifier identifying the product;
2. an endorser identifier identifying the person of influence; and
3. a link to an online location;
vii. electronically publishing the endorsement communication;
viii. determining compensation for the person of influence.

10. The system of claim 9, wherein the compensation is based at least in part on whether the endorsement is published to a social media website.

11. The system of claim 9, wherein the compensation is based at least in part on whether a consumer has followed the hyperlink of the endorsement communication.

12. The system of claim 9, wherein the compensation is based at least in part on whether a consumer has purchased the product as a result of the endorsement communication.

13. The system of claim 9, wherein the person of influence is identified based at least in part on social media activity.

14. The system of claim 9, wherein the operations further include:
a. receiving an endorsement profile from the person of interest; and
b. wherein generating an endorsement communication is based at least in part on the endorsement profile.

15. The system of claim 14, wherein the endorsement profile includes social media account information of the person of interest and electronically publishing the endorsement communication includes posting a social media message using the social media account information.

16. The system of claim 15, wherein the compensation is based at least in part on the number of likes, shares, or comments the social media message receives.

17. The system of claim 15, wherein the compensation is based at least on part on whether the social media message begins trending on a social media website where the social media message was published.

18. The system of claim 9, wherein the online location is a website of the merchant where the product can be purchased.

19. The system of claim 9, wherein the online location is a website of the merchant where the product is advertised.

20. The system of claim 9, wherein the endorsement communication includes a time period parameter reflecting a time period in which the person of interest should approve the endorsement.

21. A method for managing online endorsements, comprising:
a. generating an endorsement for a product sold by a merchant, the endorsement including:
i. endorsement parameters associated with an endorser; and
ii. a tracking identifier associated with the endorser;
b. determining, by one or more processors, that the endorser has included the endorsement in a digital communication based at least in part on
c. detecting the tracking identifier;
d. determining, by the one or more processors, whether a consumer has visited an online location associated with the merchant based at least in part on the endorsement;
e. determining compensation for the endorser for the endorsement; and
f. providing an indication to the endorser of the determined compensation.

22. The method of claim 21, wherein the endorsement parameters include at least one of:
a. a time period parameter reflecting a time period for the endorser to endorse the product;
b. a product identity parameter identifying the product;
c. an online communication parameter identifying one or more types of online communication mechanisms that the first endorser may use to endorse the product; and
d. a compensation parameter reflecting compensation for the endorser for endorsing the first product.

23. The method of claim 21, wherein the digital communication includes a social network message.

24. The method of claim 21, wherein the online location is a webpage that includes content associated with the product.

25. The method of claim 21, wherein the determining compensation for the endorser is based at least in part on the number of visitors to the online location that can be associated with the endorsement.

26. The method of claim 21, wherein the determining compensation for the endorser is based at least in part on the number of visitors associated with the endorsement that purchased the product.

27. The method of claim 21, wherein the operation of generating the endorsement includes accessing an endorsement profile associated with the endorser.

28. The method of claim 21, further including:
a. accessing a payment system associated with the endorser; and
b. providing payment to the endorser by way of the payment system, wherein the payment system is identified in the endorsement profile.

29. A method for managing online endorsements, including:
a. identifying a person of influence;
b. determining, by one or more processors, that the person of influence has identified a product provided by a merchant in a digital communication;
c. dynamically generating, by the one or more processors, an endorsement deal communication including an offer to the person of influence to endorse the product;
d. providing, by the one or more processors, the endorsement deal communication to the person of influence;
e. receiving a response to the endorsement deal communication indicating an acceptance by the person of influence to endorse the product;
f. generating an endorsement communication including:
i. a product identifier identifying the product;
ii. an endorser identifier identifying the person of influence; and
iii. a link to an online location;
g. electronically publishing the endorsement communication; and
h. determining compensation for the person of influence.

30. The method of claim 29, wherein the compensation is based at least in part on whether the endorsement is published to a social media website.

31. The method of claim 29, wherein the compensation is based at least in part on whether a consumer has followed the hyperlink of the endorsement communication.

32. The method of claim 29, wherein the compensation is based at least in part on whether a consumer has purchased the product as a result of the endorsement communication.

33. The method of claim 29, wherein the person of influence is identified based at least in part on social media activity.

34. The method of claim 29, further including:
a. receiving an endorsement profile from the person of interest; and
b. wherein generating an endorsement communication is based at least in part on the endorsement profile.

35. The method of claim 34, wherein the endorsement profile includes social media account information of the person of interest and electronically publishing the endorsement communication includes posting a social media message using the social media account information.

36. The method of claim 35, wherein the compensation is based at least in part on the number of likes, shares, or comments the social media message receives.

37. The method of claim 35, wherein the compensation is based at least on part on whether the social media message begins trending on a social media website where the social media message was published.

38. The method of claim 29, wherein the online location is a website of the merchant where the product can be purchased.

39. The method of claim 29, wherein the online location is a website of the merchant where the product is advertised.

40. The method of claim 29, wherein the endorsement communication includes a time period parameter reflecting a time period in which the person of interest should approve the endorsement.
